(19) United States
(12) Patent Application Publication
(10) Pub. No.: US 2022/0054967 A1
(43) Pub. Date: Feb. 24, 2022

(54) POWDER BED FUSION APPARATUS AND METHODS

(71) Applicant: RENISHAW PLC, Wotton-under-Edge, Gloucestershire (GB)

(72) Inventors: David Roberts MCMURTRY, Stancombe (GB); Geoffrey MCFARLAND, Wickwar (GB); Kenneth Cheng-Hoe NAI, Bristol (GB)

(73) Assignee: RENISHAW PLC, Wotton-under-Edge, Gloucestershire (GB)

(21) Appl. No.: 17/275,047

(22) PCT Filed: Sep. 10, 2019
(86) PCT No.: PCT/GB2019/052514

§ 371 Date: Mar. 10, 2021

(30) Foreign Application Priority Data
Sep. 10, 2018 (EP) 18193429.0

(51) Int. Cl. B01D 46/30; B22F 12/30; B22F 12/49; B22F 12/70; B22F 12/57; B33Y 40/00; B33Y 30/00

(52) U.S. Cl. CPC B01D 46/30; B22F 12/30; B22F 12/49; B33Y 30/00; B22F 12/57; B33Y 40/00; B22F 12/70

(57) ABSTRACT

A powder bed fusion apparatus and method includes a build platform for supporting a powder bed onto which layers of a powder can be deposited, a scanner for scanning an energy beam over each layer to fuse selected regions of the powder bed and a gas flow circuit for passing a flow of gas over the powder bed. The gas flow circuit includes a filter assembly including a filter housing through which the gas flows, the filter housing containing a granulate, preferably powder, filter medium for filtering particles from the gas flow. The powder filter medium may correspond to powder used to form the powder bed such as being of the same material as the powder used to form the powder bed.

### FIELD OF INVENTION

This invention concerns powder bed fusion apparatus and methods in which selected areas of a powder bed are solidified in a layer-by-layer manner to form a workpiece. The invention has particular, but not exclusive application, to selective laser melting (SLM) and selective laser sintering (SLS) apparatus.

### BACKGROUND

Powder bed fusion apparatus produce objects through layer-by-layer solidification of a material, such as a metal powder material, using a high-energy beam, such as a laser or electron beam. A powder layer is formed across a powder bed contained in a build sleeve by lowering a build platform to lower the powder bed, dosing a heap of powder adjacent to the lowered powder bed and spreading the heap of powder with a recoater across (from one side to another side of) the powder bed to form the layer. Portions of the powder layer corresponding to a cross-section of the workpiece to be formed are then solidified through irradiating these areas with the beam. The beam melts or sinters the powder to form a solidified layer. After selective solidification of a layer, the powder bed is lowered by a thickness of the newly solidified layer and a further layer of powder is spread over the surface and solidified, as required.

During SLM of material, in particular metals, the melt pool emits a hot, high-speed vapour plume that cools to form a fine mist of metal ‘condensate’ nano-particles. In addition, larger irregular spatter particles are ejected from the boiling melt pool. Furthermore, the pressure drop caused by the motion of the vapour plume draws in powder near the melt pool, casting it upwards away from the powder bed.

These process emissions should be removed from the build chamber to prevent undesirable effects, such as the gas-borne particles interfering with the passage of the laser beam to the powder bed. It is known to remove the processing emissions from the build chamber by introducing a gas flow through the chamber in which the condensate, spatter and other particles are entrained, the particles exiting the chamber along with the gas flow through an exhaust.

Gas collected by the exhaust is recirculated through a gas circuit back to the nozzle under the control of a pump. A filter in the gas circuit filters condensate from the recirculated gas.

WO2010/007394 discloses a filter arrangement in which the filter housing containing the filter element can be sealed and removed from the apparatus such that the filter housing can be flooded with water to entrap and neutralise particles trapped on the filter element. After flooding, the filter element is removed from the filter housing for disposal.

A problem with such a system is that the apparatus requires regular servicing to replace the filter elements (typically paper filters) and the neutralised filter element, comprising a combination of the original paper filter with condensate and water trapped thereon, must be disposed of as hazardous waste.

### SUMMARY OF INVENTION

According to a first aspect of the invention there is provided a powder bed fusion apparatus comprising; a build platform for supporting a powder bed onto which layers of a powder can be deposited, a scanner for scanning an energy beam over each layer to fuse selected regions of the powder bed and a gas flow circuit for passing a flow of gas over the powder bed, the gas flow circuit comprising a filter assembly for filtering particles from the gas flow. The filter assembly may comprise a filter housing through which the gas flows, the filter housing containing a filter medium for filtering particles from the gas flow. The filter medium for filtering particles may comprise a granulate filter medium, such as a powder filter medium, and preferably comprises a powder corresponding to powder used to form the powder bed. The filter assembly in an unused state, i.e. before the filter assembly is used to filter particles, comprises the powder filter medium, i.e. the powder filter medium is preloaded into the filter housing before the filter assembly is used to filter particles from the gas flow.

The powder filter medium may be of the same material as the powder used to form the powder bed. The powder filter medium may have substantially the same particle size characteristic, such as substantially the same particle size distribution, maximum particle size and/or minimum particle size, as the powder used to form the powder bed.

The condensate particles entrained in the gas flow are formed from the material of the powder bed. Accordingly, by using corresponding material to filter the particles from the gas flow, the resultant combination of the filter medium and the filtered material is a powder that can be reused in a subsequent build. Accordingly, the generation and disposal of hazardous waste material is reduced and, possibly, avoided altogether.

The filter housing and/or a filter element retained in the filter housing may be arranged to retain a bulk of powder as the filter medium for filtering particles from the gas flow. The bulk of the powder may act as a depth filter for capturing particles entrained in the gas throughout the bulk. The filter housing may comprise a gas inlet and a gas outlet arranged such that the gas flows through the bulk of powder retained within the filter housing. The bulk of powder may be such that a minimum path length through the bulk of powder for gas flowing from the gas inlet to the gas outlet is at least the order of millimetres, such as 1 or more millimetres, and preferably tens of millimetres, such as 50 millimetres or more. The filter housing may be arranged such that a flow velocity from the gas inlet is greater than a flow velocity through the bulk of powder.

The filter assembly may comprise a retaining wall for retaining the powder filter medium within the filter housing, the retaining wall having sufficient porosity to allow the gas to flow therethrough. The retaining wall may comprise a lattice structure, for example built using additive manufacturing or a porous ceramic. The lattice structure may be packed with the powder filter medium for filtering particles from the gas flow.

A pore size of the lattice structure may be sufficient to contain the powder filter medium and preferably, is such that the gas flow flowing therethrough does not carry away the powder filter medium, for example between 100 μm and 500 μm. An average pores size of the lattice structure may be of the order to one or more hundreds of micrometres, for example between 100 μm and 500 μm. Powder used in additive manufacturing tends to have a maximum particle size of less than 100 μm. It is believed that an average pore size of between 100 μm and 500 μm is sufficient to restrain the particles such that the particles of the powder filter medium substantially remain in place whilst gas flows therethrough.

The lattice structure may provide a tortuous path for the gas flow.

A bulk shape of the lattice structure may comprise a hollow three-dimensional sleeve having an outlet from the internal volume for the gas, such as a hollow polyhedron. For example, the bulk shape may comprise a hollow prism, such as a hollow cylinder, a hollow frustum or the like. The lattice structure may be arranged in the filter housing such that gas flows from an outside of the hollow three-dimensional sleeve through the lattice structure to the inside of the hollow three-dimensional sleeve.

The lattice structure may be made of the same material as the powder filter medium. In this way, the lattice structure as a source of contamination is avoided. The lattice structure may have been built using a powder bed fusion method.

The filter assembly may comprise an outlet retaining wall for preventing the powder from escaping from the filter housing via the gas outlet. The filter assembly may comprise an inlet retaining wall for preventing the powder from escaping from the filter housing via the gas inlet. The inlet retaining wall may form a/the sleeve for containing the powder, the sleeve spaced from a wall of the filter housing.

The gas inlet may be arranged such that the gas flow is delivered into the filter housing substantially at a tangent to the sleeve. In this way, the gas flow does not directly impact the sleeve, reducing the chance that particles in the gas flow collect on a small section of the sleeve. The filter housing may be arranged to open out from the gas inlet such that an average gas flow velocity from the gas inlet is greater than an average gas flow velocity through the openings in the inlet retaining wall. To increase the chance that the particles in the gas flow are captured by the retaining wall(s) and/or powder filter medium it is advantageous for the gas to flow through the retaining wall(s) and/or powder slowly.

The filter housing may comprise a powder inlet for feeding the powder filter medium into the filter housing. The powder inlet may be arranged to feed powder into the lattice structure, preferably at a top such that powder filter medium descends through the lattice structure under gravity.

The filter housing may comprise a powder outlet for removing the powder filter medium from the filter housing. The powder outlet may be located at a bottom of the filter housing. The powder outlet may be connected to a doser for controlling dispense of the powder filter medium from the outlet. The doser may dose the powder filter medium to be formed into layers of the powder bed. For example, the doses may be as described in WO2010/007396, which is incorporated herein by reference.

The filter assembly may comprise a membrane filter between the lattice structure and the gas outlet. The membrane filter may be a mesh filter, for example, for filtering out particles having a size less than 20 μm, and more preferably less than 10 μm.

The filter assembly may comprise a vibrating mechanism to vibrate the filter housing and/or the filter element to assist the flow of the filter medium through the filter housing and/or filter element.

According to a second aspect of the invention there is provided a powder bed fusion method comprising: forming layers of a powder bed. scanning an energy beam over each layer to fuse selected regions of the powder bed to build an object, passing a flow of gas over the powder bed and filtering particles from the gas flow using a filer medium. The filter medium for filtering particles may comprise a powder, and preferably comprises a powder corresponding to powder used to form the powder bed. The powder filter medium may be of the same material as the powder used to form the powder bed. The powder filter medium may have substantially the same particle size characteristic, such as substantially the same particle size distribution, maximum particle size and/or minimum particle size, as the powder used to form the powder bed.

The method may comprise using the powder filter medium, after the powder has been used to capture particles in the gas flow, to form layers of the powder bed in the or a further powder bed fusion method.

The method may comprise transporting powder recovered from the powder bed and/or the spreading of the powder to form layers and using the recovered powder as the powder filter medium.

The method may comprise replacing the filter medium during the building of the object. Replacing the filter medium may comprise generating a flow of the filter medium through a filter housing. The flow may be a steady flow or intermittent. For example, the filter medium may be delivered to the filter housing in doses or batches.

According to a third aspect of the invention there is provided a filter element for use in filtering particles from a gas flow in a powder bed fusion apparatus, the filter element comprising a lattice structure built layer-by-layer using a powder bed fusion method. Powder bed fusion methods are capable of building the fine lattice structure used for retaining the granulate/powder filter medium in accordance with the invention. The filter element may have been formed by solidifying, such as sintering, powder to an initial lattice structure, for example by heating the initial lattice structure when containing powder. This may produce a final lattice structure with a smaller average pore size than the initial lattice structure built using a powder bed fusion method. The powder may be made of the same material as the initial lattice structure.

According to a fourth aspect of the invention there is provided a powder bed fusion apparatus comprising; a build platform for supporting a powder bed onto which layers of a powder can be deposited, a scanner for scanning an energy beam over each layer to fuse selected regions of the powder bed and a gas flow circuit for passing a flow of gas over the powder bed, the gas flow circuit comprising a filter assembly for filtering particles from the gas flow, the filter assembly comprising a filter housing through which the gas flows and a filter element contained in the filter housing for filtering particles from the gas flow. The filter element may comprise a three-dimensional lattice, e.g. not a two-dimensional lattice/mesh folded or otherwise deformed to extend in three-dimensions. The filter element may comprise a lattice structure built of the same material as the powder of the powder bed.

### DESCRIPTION OF THE DRAWINGS

Embodiments of the invention will now be described, by example only, with reference to the following drawings, in which:

FIG. 1 is a schematic of an additive manufacturing apparatus according to a first embodiment of the invention;

FIG. 2 is a cross-sectional view of the filter assembly according to the first embodiment of the invention;

FIG. 3 is a perspective view of a filter element according to an embodiment of the invention;

FIG. 4 is a cross-sectional view of a filter assembly according to a further embodiment of the invention incorporating the filer element of FIG. 3;

FIG. 5 is a cross-sectional view of the filter assembly shown in in FIG. 4 along the line A-A;

FIG. 6 is a cross-sectional view of a hexagonal lattice structure used for the filter element with an adjacent hexagonal lattice structure superimposed thereon to illustrate an offset between the parallel adjacent hexagonal lattice structures;

FIG. 7 is a cross-sectional view of vertical struts used to join the hexagonal lattice structures;

FIGS. 8 and 9 are perspective views of unit cells for lattice structures according to other embodiments of the invention; and

FIG. 10 is a schematic view of a powder bed fusion apparatus according to another embodiment of the invention incorporating the filter assembly of FIGS. 4 to 7.

### DESCRIPTION OF EMBODIMENTS

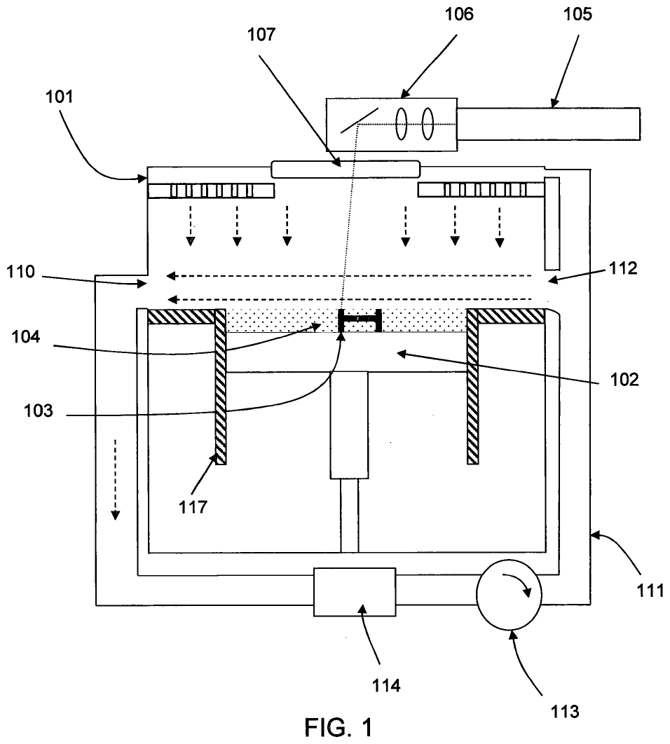

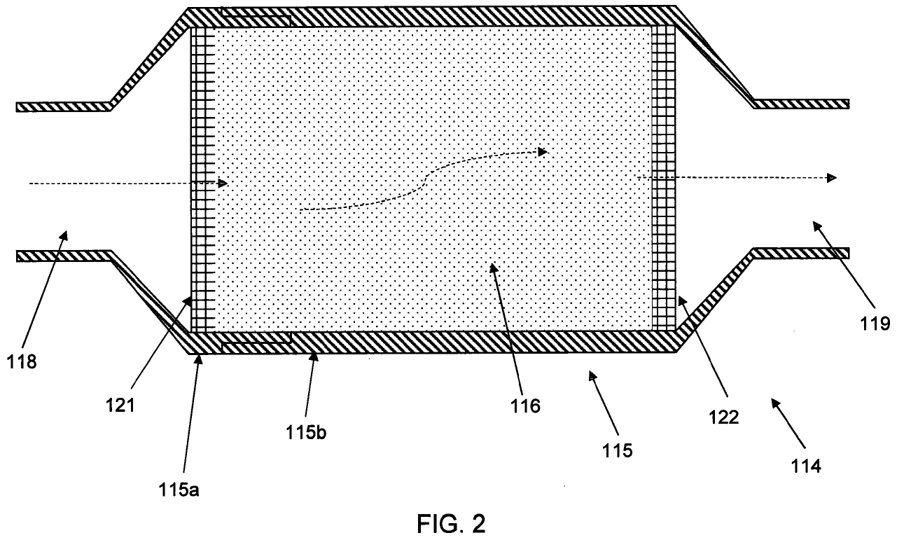

Referring to FIGS. 1 and 2, a powder bed fusion apparatus according to an embodiment of the invention comprises a build chamber 101 sealable from the external environment for maintaining a controlled atmosphere at a working surface 104a of a powder bed 104. Contained within the build chamber 101 is a build platform 102 for supporting an object 103 built by selective laser melting powder of the powder bed 104. The platform 102 is lowerable in a sleeve 117 as successive layers of the object 103 are formed. Layers of powder 104 are formed as the object 103 is built by dispensing apparatus 108 and a wiper 109. For example, the dispensing apparatus 109 may be apparatus as described in WO2010/007396. A laser module 105 generates a laser for melting the powder 104, the laser directed as required by a scanner in the form of optical module 106. The laser enters the build chamber via a window 107.

A gas circuit is provided for generating a gas flow across the powder bed formed on the build platform 102. The gas circuit comprises a gas nozzle 112 and gas exhaust 110 arranged either side of the build sleeve 117 for generating a gas flow across the powder bed 104 formed in the build sleeve 117. The gas nozzle 112 and gas exhaust 110 are arranged to produce a laminar gas flow local to the working surface 104a of the powder bed 104. The process emissions generated by the laser melting process are carried away by the gas flow. The gas circuit is completed by a gas recirculation loop 111, which re-circulates the gas from the gas exhaust 110 to the gas nozzle 112. The gas recirculation loop 111 comprises a pump 113 for driving the gas around the gas circuit and a filter assembly 114, upstream of the pump 113, for filtering particles from the gas flow. It will be understood that more than one gas inlet 112 may be provided in the build chamber 101. In this embodiment, an array of apertures 150 are provided in a roof of the build chamber 101 to provide a steady downwards flow of gas away from the window 107.

Referring to FIG. 2, in this embodiment, the filter assembly comprises a filter housing 115 defining a chamber for retaining a filter medium in the form of a bulk volume of powder 116, a gas inlet 118 and a gas outlet 119. Retaining walls 121, 122 are provided in the filter housing 115 for retaining the powder therein. The retaining walls 121, 122 may be porous with a structure that allows the gas to flow therethrough whilst retaining the powder therebetween. For example, each retaining wall 121, 122 may be a lattice structure built using a powder bed fusion process or a porous ceramic. A mesh filter (not shown) is located in the gas outlet to capture any powder that does pass through the retaining wall 122.

The filter housing 115 may comprise two separable portions 115a, 115 that are detachably secured together by appropriate fixing means, for example a screw thread. A user can then separate the filter housing 115 into two portions to remove the powder 116 and/or retaining walls 121, 122 for replacement, when required.

In one embodiment, the powder may be of the same material and similar particle size as that used in the powder bed, the powder being preloaded into the filter housing 115 before the filter assembly 114 is used for filtering particles from the gas flow. When a predefined condition has been met, for example the filtering capability of the powder has diminished below a predefined level or the powder has been used to filter the gas flow for a predefined length of time, the filter housing 115 may be opened and the powder replaced. The “used” powder may then be used in the formation of a powder bed in a powder bed fusion process. In this way, hazardous waste is avoided.

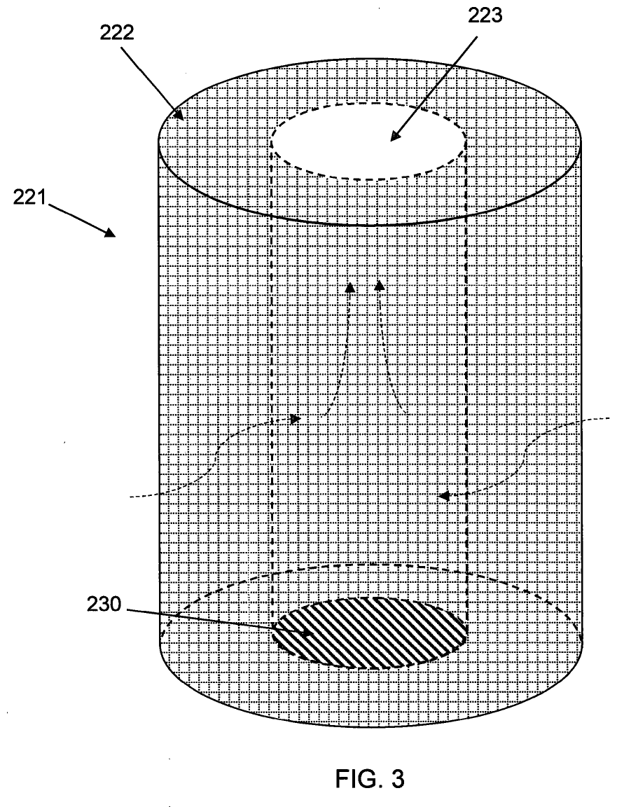

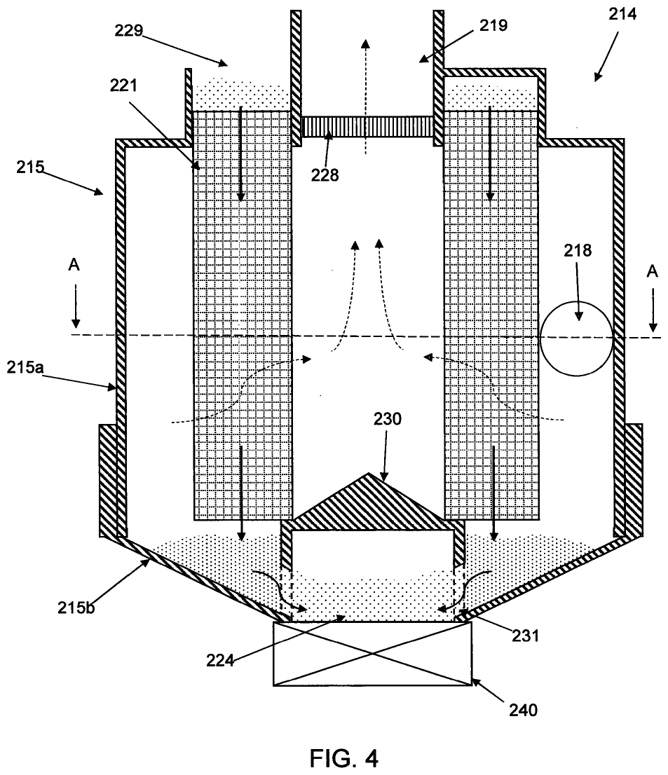

FIG. 3 shows a filter element or cartridge 221 according to an embodiment of the invention. The filter element 221 comprises a lattice structure 222 in the general shape of a hollow cylindrical sleeve. The lattice structure 222 may be blocked at one end, for example by a separate closure member 230, for example a plate or plug of a housing in which the filter element 221 is located, or a non-porous wall integral with the lattice structure 221. The filter element 221 can be located in a housing such that gas can flow from an outside of the sleeve to the hollow interior 223 of the sleeve. The filter element 221 is located within a housing such that the hollow interior 223 of the sleeve is in gaseous communication with an outlet of the filter housing (the gas flow is indicated by the dotted lines). Powder for filtering particles of the gas flow can be retained within the lattice structure 221 itself and/or within the hollow interior 223 of the filter element 221. The filter element 221 may be used in a filter assembly like the one shown in FIG. 2, wherein a batch of powder is retained within the container until predefined criteria are met and then the batch of powder is changed, or in a filter assembly 214, wherein there is a flow of powder through the filter element during the powder bed fusion process, as now described with reference to FIG. 4.

In FIG. 4, the filter element 221 is located in a housing 215. The filter housing 215 is made of two separate portions, a first body 215a having a generally cylindrical shape and a second body 215b having a frusto-conical shape that tapers to a powder outlet 224. The first and second bodies 215a, 215b can be secured together to form the filter housing 215 by a suitable fastening, such as a screw thread.

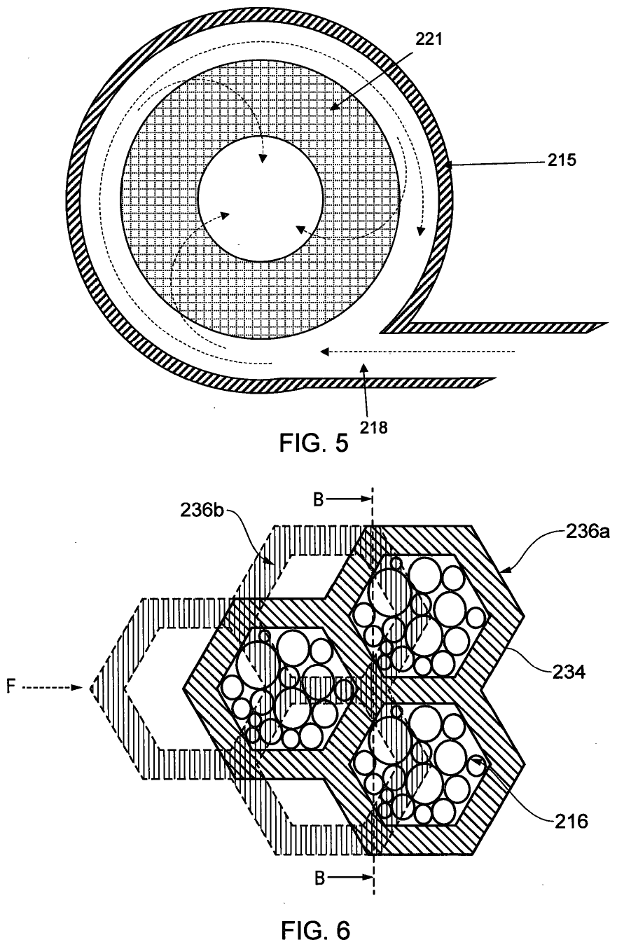

The filter housing 215 comprises a gas inlet 218. The gas inlet 218 is arranged such that gas enters the filter housing 215 in a direction that is substantially tangential to the circular periphery of the cylindrical shaped filter element 221 (as shown in FIG. 5). This helps to avoid capture of the particles in the gas predominately occurring at a single location in the filter element 221. Gas may be delivered across the powder bed 104 at a relatively high velocity compared to a gas velocity through the filter element 221. To achieve a sufficiently slow gas flow, the area of the openings in the lattice structure 218 is much greater than the area of the inlet 218 to the filter housing and/or the gas exhaust 112 from the build chamber 101. The relatively low gas velocity through the filter element 221 helps the capture of the particles from the gas.

The filter housing 215 comprises a gas outlet 219. The gas outlet 219 is arranged to be in gaseous communication with the hollow interior 223 of the lattice structure 221 when the filter element 221 is located within the filter housing 215. A fine mesh filter 228 is provided in the gas outlet 219 to capture any particles that remain in the gas flow. For example, the mesh filter 228 may have an ultrafine 10 micrometre mesh.

The filter housing 215 further comprises a powder inlet 229. The powder inlet 229 feeds powder into the top of the lattice structure 222 of the filter element 221 when the filter element 221 is located in the filter housing 215. During use, the powder can trickle down through the lattice 222.

The second body 215b of the filter housing comprises a closure member in the form of plug 230 that engages the lattice structure 222 of the filter element 221 to locate the filter element 221 in the filter housing 215 and to block a lower open end of sleeve of the filter element 221. The plug 230 has a conical end such that as the first and second bodies 215a, 215b are secured together, the conical end of the plug 230 engages with the end of the sleeve to locate the sleeve centrally within the filter housing 215 and to push the sleeve into the annulus defined by the powder inlet 229. The conical surface of the plug 230 also aids in the flow of powder that enters the hollow interior 223 of the sleeve back through the lattice stricture 222 to the powder outlet 224. The plug may comprise apertures 231 therein for allowing the flow of powder from the tapered section of the filter housing 215 to the powder outlet 224. The angles of surfaces on which the powder collects, such as the tapered section of the filter housing 215 and the conical surface of the plug, may be selected to be greater than an angle of repose of the powder.

A dispenser 240 for controlling the dispense of powder from the filter housing 215 is provided in communication with the powder outlet 224. The dispenser 240 may be a doser as described in WO2010/007396.

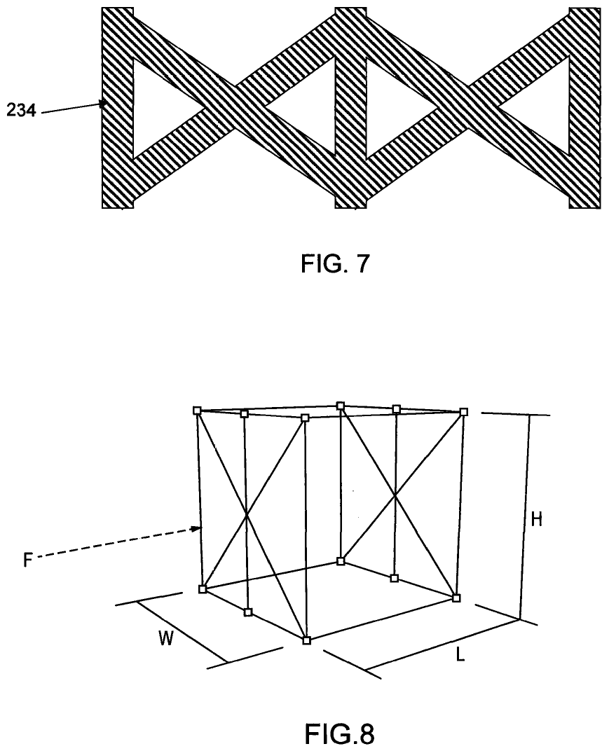

Referring to FIG. 6, the lattice structure 222 is formed by struts 234 that define pores that, in use, are filled with powder 216. The lattice structure 222 may be arranged such that in the vertical direction, and preferably in the vertical and horizontal directions, any opening between struts 234 is at least partially obscured by an earlier or later strut. In FIG. 6, hexagonal lattices in vertically spaced horizontal planes (236a, 236b) are offset relative to each other. The hexagonal lattice (not shown) in the plane following 236b may be offset to lattices 236a and 236b and joined to the vertices of hexagonal lattice 236b that are not directly joined to hexagonal lattice 236a. In this way, powder cannot flow directly downwards through the openings in the lattices, but the powder particles are forced to deviate in the horizontal direction. FIG. 7 illustrates a pattern of struts for joining the vertices of the hexagonal lattices along the line B-B. The smaller pores in cross-sections of the lattice structure perpendicular to direction of gas flow F (as shown in FIG. 7) helps to limit the flow of powder to the hollow interior 223.

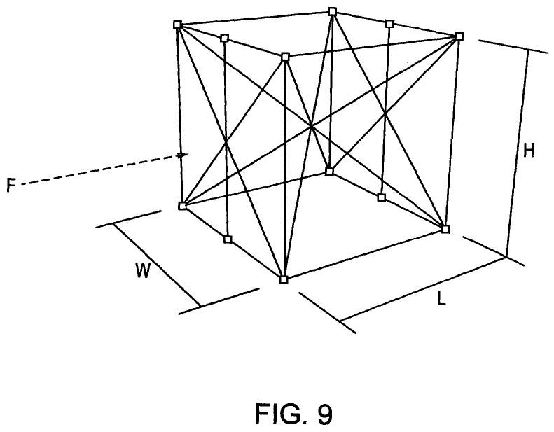

It will be understood however, that other regular or irregular lattice structures could be used. FIGS. 8 and 9 illustrate unit cells for other possible lattice structures. These lattice structures are based upon square lattice structures in spaced horizontal planes. However, it will be understood that the arrangement of vertical structs shown in FIGS. 8 and 9 may also be used other horizontal lattice structures, such as the hexagonal lattice structures shown in FIG. 6 or a triangular lattice structure.

A density of the lattice structure may be varied as one moves from the outside to the hollow interior 223 of the sleeve. For example, the lattice structure 223 may be arranged such that density of the lattice structure increases as one moves towards the hollow interior of the sleeve (with a corresponding reduction in the average pore size). This may help to limit the flow of powder to the hollow interior 223. WO2009/144434, which is incorporated herein by reference, describes a method of designing a lattice structure using a mathematical function such that the nature of a porous portion of a lattice can be changed systematically and in a particular direction.

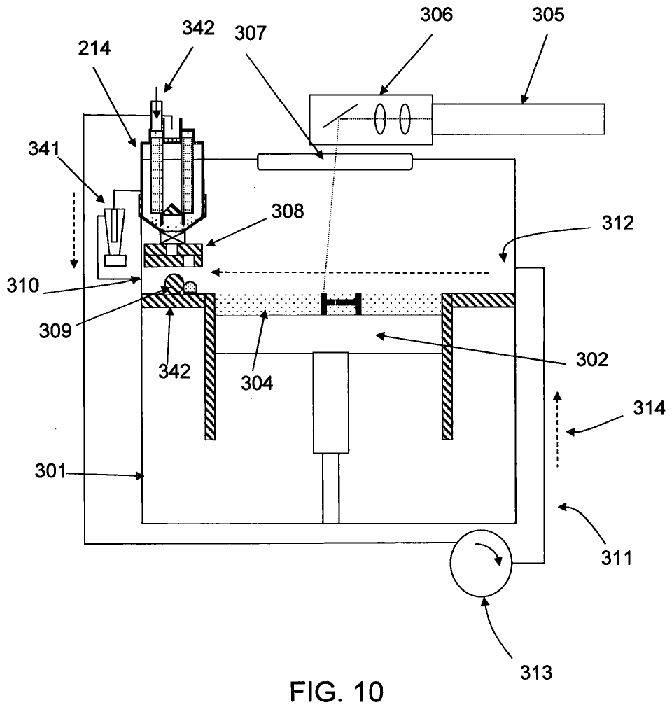

Referring to FIG. 10, the filter assembly 214 is incorporated into a gas recirculation loop 311 of a powder bed fusion apparatus 300. The same reference numerals but in the series 300 are used to refer to features of this embodiment that correspond to features of the previous embodiment described with reference to FIG. 1. Features that are the same will not be described in detail again and reference is made to the above description of these features.

In this embodiment, the gas recirculation loop is provided with a cyclone separator 341 for separating larger particles from the gas flow. Such particles may typically be those having a particle size over 10 micrometres. The cyclone separator 341 is upstream of the filter assembly 214 such that gas flows through the cyclone separator 341 before passing through the filter assembly 214. This arrangement protects the filter assembly from becoming blocked by the larger particles. The larger particles may be collected in a bottle or transported to a storage hopper for remixing with powder to be used to form the powder bed 104.

Powder is fed to the filter assembly from a powder source 342. The powder source may be a powder hopper, which may form part of a powder transport loop for transporting powder recovered from the build chamber 101 back to a doser 308. An example of such a powder transport system is disclosed in WO2016/079494. The powder transport loop and gas circuit for forming the gas knife may be integrated into a single gas flow circuit as described in WO2019/081894.

The powder supplied to the filter assembly 214 trickles down through the lattice structure 222 such that the lattice structure becomes full of powder. Small gaps between the powder particles form a tortuous path for the gas to flow therethrough. As the gas flows through the powder held in the lattice structure 221, particles entrained in the gas are captured in the powder 216. The particles entrained in the gas may be left behind because of the directional changes the gas undergoes as it moves through the particles and/or Van de Waals forces attracting the small particles entrained in the gas to the powder particles within the lattice 222. As a result, there is a significant reduction in solid particles entrained in the gas entering the hollow interior 223 from the lattice structure 222 compared to the gas entering into the lattice structure 222.

The gas exits the filter assembly via the gas outlet 219 through the mesh filter 228. The mesh filter traps particles that remain entrained in the gas even after passing through the lattice filled with powder. The gas is then pumped back to the gas nozzles 112 in the build chamber 101.

The powder together with the captured particles trickles under gravity through the lattice structure 221, finally exiting the lattice to be collected at the bottom ofthe filter housing 215. The flow of powder through the lattice may be assisted through vibrations created by the buffeting of the lattice by the gas flow. However, an additional vibrating mechanism (not shown) may be provided, such as an ultrasonic vibrator, for vibrating the lattice structure 222 to assist the powder flow through the lattice structure.

Powder is dosed from the filter housing 215 onto the processing plate 342 under the control of a doser 308. The dosed powder is spread by a recoater 308 to form layers of the powder bed 304. This dosed powder will include the particles captured from the gas flow. In this way, the processing emissions are recycled back into the powder bed fusion process eliminating or at least reducing a need to externally handle and/or dispose of these particles trapped on a filter element. These particles include particles much smaller than the minimum particle size for powder conventionally processed in a powder bed fusion apparatus (powder typically having particle sizes ranging between 10 and 60 micrometres, rather than the nanometre sized particles of the “condensate”). It is believed that such small particles can be successfully processed in a powder bed fusion apparatus. Furthermore, with the constant trickle and intermixing of the smaller particles of the processing emissions with the larger particles of the powder fed to the filtering assembly 214, a powder having consistent characteristics will be delivered from the doser 308 throughout the build.

It will be understood that modifications and alterations may be made to the above described embodiments without departing from the invention as described herein.

In all of the embodiments described above, two of the filter assemblies 114, 214 may be used in a parallel arrangement, as is described in WO2010/026396 and WO2016/079494. This enables one of the filter assemblies to be serviced whilst the other filter assembly is being used to filter particles from the gas flow. Servicing of the filter assembly may comprise cleaning of a filter element that has become blocked and/or replacing a filter element that has become damaged.

The powder from the powder source 342 may be filtered to remove particles below a predetermined threshold, such as below 30 μm, for example using a mesh filter or a cyclone separator. Removing the smaller particles from the powder may facilitate the trickle of particles through the lattice as the powder with such small particles removed may flow more easily than powder with the smaller particles.

The filter element 214 may be cooled to facilitate the capture of the particles from the gas flow. Particles entrained in the gas flow may be more likely to collect on colder surfaces than warmer surfaces.

1. A powder bed fusion apparatus comprising; a build platform for supporting a powder bed onto which layers of a powder can be deposited, a scanner for scanning an energy beam over each layer to fuse selected regions of the powder bed and a gas flow circuit for passing a flow of gas over the powder bed, the gas flow circuit comprising a filter assembly comprising a filter housing through which the gas flows, the filter housing containing a powder filter medium for filtering particles from the gas flow.

2. A powder bed fusion apparatus according to claim 1, wherein the filter assembly in an unused state comprises the powder filter medium and/or wherein the powder filter medium corresponds to powder used to form the powder bed.

3. A powder bed fusion apparatus according to claim 1, wherein the filter housing and/or a filter element retained in the filter housing is arranged to retain a bulk of the powder filter medium as a depth filter for capturing particles entrained in the gas flow throughout the bulk.

4. A powder bed fusion apparatus according to claim 1, wherein the filter assembly comprises a retaining wall for retaining the powder filter medium within the filter housing, the retaining wall having sufficient porosity to allow the gas to flow therethrough.

5. A powder bed fusion apparatus according to claim 1, wherein the retaining wall comprises a lattice structure and, wherein the lattice structure may be packed with the powder filter medium for filtering particles from the gas flow.

6. A powder bed fusion apparatus according to claim 5, wherein a bulk shape of the lattice structure comprises a hollow three-dimensional sleeve and the lattice structure may be arranged in the filter housing such that gas flows from an outside of the hollow three-dimensional sleeve through the lattice structure to the inside of the hollow three-dimensional sleeve.

7. A powder bed fusion apparatus according to claim 5, wherein the lattice structure is made of the same material as the powder and, may have been built using a powder bed fusion method.

8. A powder bed fusion apparatus according to claim 1, wherein the filter housing comprises a powder inlet for feeding the powder filter medium into the filter housing.

9. A powder bed fusion apparatus according to claim 5, wherein the filter housing comprises a powder inlet for feeding the powder filter medium into the filter housing, the powder inlet arranged to feed powder filter medium into the lattice structure.

10. A powder bed fusion apparatus according to claim 1, wherein the filter housing may comprise a powder outlet for removing the powder filter medium from the filter housing, wherein the powder outlet may be located at a bottom of the filter housing and the powder outlet may be connected to a doser for controlling dispense of the powder filter medium from the outlet and the doser may dose the powder filter medium to be formed into layers of the powder bed.

11. A powder bed fusion apparatus according to claim 1, wherein the filter assembly comprises a vibrating mechanism to vibrate the filter housing and/or the filter element to assist the flow of the powder filter medium through the filter housing and/or filter element.

12. A powder bed fusion method comprising: forming layers of a powder bed. scanning an energy beam over each layer to fuse selected regions of the powder bed to build an object, passing a flow of gas over the powder bed and filtering particles from the gas flow using a powder filter medium.

13. A method according to claim 12, comprising using the powder filter medium, after the powder filter medium has been used to capture particles in the gas flow, to form layers of the powder bed in the or a further powder bed fusion method.

14. A method according to claim 12, comprising transporting powder recovered from the powder bed and/or the spreading of the powder to form layers and using the recovered powder as the powder filter medium.

15. A method according to claim 12, comprising replacing the powder filter medium during the building of the object, wherein replacing the powder filter medium may comprise generating a flow of the powder filter medium through a filter housing.
